(19) United States
(12) Patent Application Publication
(10) Pub. No.: US 2022/0407868 A1
(43) Pub. Date: Dec. 22, 2022

(54) DETECTION DEVICE, VEHICLE, DETECTION METHOD, AND DETECTION PROGRAM

(71) Applicants: SUMITOMO ELECTRIC INDUSTRIES, LTD., Osaka-shi, Osaka (JP); SUMITOMO WIRING SYSTEMS, LTD., Yokkaichi-shi, Mie (JP); AUTONETWORKS TECHNOLOGIES, LTD., Yokkaichi-shi, Mie (JP)

(72) Inventors: Hiroyuki TSUKAMOTO, Osaka-shi (JP); Hiroshi UEDA, Yokkaichi-shi (JP); Naoki ADACHI, Yokkaichi-shi (JP); Shinichi AIBA, Yokkaichi-shi (JP); Fumiya ISHIKAWA, Yokkaichi-shi (JP); Shogo KAMIGUCHI, Yokkaichi-shi (JP)

(73) Assignees: SUMITOMO ELECTRIC INDUSTRIES, LTD., Osaka-shi, Osaka (JP); SUMITOMO WIRING SYSTEMS, LTD., Yokkaichi-shi, Mie (JP); AUTONETWORKS TECHNOLOGIES, LTD., Yokkaichi-shi, Mie (JP)

(21) Appl. No.: 17/780,199

(22) PCT Filed: Aug. 28, 2020
(86) PCT No.: PCT/JP2020/032583

§ 371 Date: May 26, 2022

(30) Foreign Application Priority Data
Dec. 5, 2019 (JP) 2019-219993

(51) Int. Cl. H04L 9/40; B60R 16/023

(52) U.S. Cl. CPC H04L 63/123; H04L 63/1416; B60R 16/023; H04W 4/40

(57) ABSTRACT

A detection device includes: an acquisition unit configured to acquire a target distribution that is a distribution of reception intervals of periodic messages transmitted in an in-vehicle network; an extraction unit configured to extract a part of the target distribution acquired by the acquisition unit, in accordance with a predetermined criterion; and a detection unit configured to perform a detection process of detecting an unauthorized message, based on the part, of the target distribution, extracted by the extraction unit.

### TECHNICAL FIELD

The present disclosure relates to a detection device, a vehicle, a detection method, and a detection program.

This application claims priority on Japanese Patent Application No. 2019-219993 filed on Dec. 5, 2019, the entire content of which is incorporated herein by reference.

### BACKGROUND ART

PATENT LITERATURE 1 (Japanese Laid-Open Patent Publication No. 2014-146868) discloses a network device as follows. That is, the network device includes a communication unit that receives data, a time management unit that manages a reception time when the data is received, and a control unit that processes the received data. The network device periodically receives and processes data. The control unit records the reception time in the time management unit, for each of identifiers included in the data received by the communication unit. When first data, which has the same identifier as reference data and has a data reception interval shorter than a predetermined cycle, has been received, if second data having the same identifier as the first data is received until the predetermined cycle elapses from when the reference data is received, the control unit performs a cycle abnormality detection process. When data having the same identifier as the first data has not been received until the predetermined cycle elapses, the control unit performs a predetermined process with respect to the first data.

Meanwhile, PATENT LITERATURE 2 (US Patent Application Publication No. 2017/0286675) discloses a detection method as follows. That is, this detection method is a method for detecting intrusions in a vehicle network. This method includes: receiving, by a recipient ECU (Electronic Control Unit), a plurality of messages that are periodically transmitted from a transmitting ECU to the recipient ECU via a vehicle network and that do not include time stamp information; determining, by the recipient ECU, a clock skew for the transmitting ECU, based on the plurality of messages; detecting, by the recipient ECU, a sudden change in the clock skew for the transmitting ECU by comparing the clock skew for the transmitting ECU with a baseline value; and identifying, by the recipient ECU, that the transmitting ECU is compromised, based on the detected sudden change in the clock skew for the transmitting ECU.

### CITATION LIST

### Patent Literature

PATENT LITERATURE 1: Japanese Laid-Open Patent Publication No. 2014-146868
PATENT LITERATURE 2: US Patent Application Publication No. 2017/0286675

### Non-Patent Literature

NON-PATENT LITERATURE 1: O. Cappe, one other, “Online expectation maximization algorithm for latent data models”, Journal od the Royal Statistics Society: Series B (Statistical Methodology), Vol. 71, P. 593-613, 2009

### SUMMARY OF THE INVENTION

### Solution to Problem

A detection device according to the present disclosure is a detection device that detects an unauthorized message in an in-vehicle network. The detection device includes: an acquisition unit configured to acquire a target distribution that is a distribution of reception intervals of periodic messages transmitted in the in-vehicle network; an extraction unit configured to extract a part of the target distribution acquired by the acquisition unit, in accordance with a predetermined criterion; and a detection unit configured to perform a detection process of detecting an unauthorized message, based on the part, of the target distribution, extracted by the extraction unit.

A detection method according to the present disclosure is a detection method performed by a detection device that detects an unauthorized message in an in-vehicle network. The method includes: acquiring a target distribution that is a distribution of reception intervals of periodic messages transmitted in the in-vehicle network; extracting a part of the acquired target distribution in accordance with a predetermined criterion; and performing a detection process of detecting an unauthorized message, based on the extracted part of the target distribution.

A detection program according to the present disclosure is a detection program used in a detection device that detects an unauthorized message in an in-vehicle network. The detection program causes a computer to function as: an acquisition unit configured to acquire a target distribution that is a distribution of reception intervals of periodic messages transmitted in the in-vehicle network; an extraction unit configured to extract a part of the target distribution acquired by the acquisition unit, in accordance with a predetermined criterion; and a detection unit configured to perform a detection process of detecting an unauthorized message, based on the part, of the target distribution, extracted by the extraction unit.

One mode of the present disclosure can be realized as a semiconductor integrated circuit that realizes a part or the entirety of the detection device, or as a system including the detection device. Moreover, one mode of the present disclosure can be realized as a semiconductor integrated circuit that realizes a part or the entirety of a system including the detection device, or as a program that causes a computer to execute process steps in the system including the detection device.

### BRIEF DESCRIPTION OF DRAWINGS

FIG. 1 shows a configuration of an in-vehicle communication system according to an embodiment of the present disclosure.

FIG. 2 shows a configuration of a bus connection device group according to the embodiment of the present disclosure.

FIG. 3 shows a configuration of a gateway device in the in-vehicle communication system according to the embodiment of the present disclosure.

FIG. 4 shows examples of a probability density function and a cumulative distribution function generated by an extraction unit in the gateway device according to the embodiment of the present disclosure.

FIG. 5 shows examples of a probability density function and a cumulative distribution function generated by the extraction unit in the gateway device according to the embodiment of the present disclosure.

FIG. 6 shows change over time of a standard deviation calculated by a detection unit in the gateway device according to the embodiment of the present disclosure.

FIG. 7 is a flowchart showing an example of an operation procedure when the gateway device performs a detection process in the in-vehicle communication system according to the embodiment of the present disclosure.

FIG. 8 is a flowchart showing an example of an operation procedure when the gateway device determines a criterion of an extraction section of the probability density function, in the in-vehicle communication system according to the embodiment of the present disclosure.

FIG. 9 shows an example of a connection topology of an in-vehicle network according to the embodiment of the present disclosure.

FIG. 10 shows a result of verification performed by the inventors of the present application.

FIG. 11 shows a result of verification performed by the inventors of the present application.

FIG. 12 shows a result of verification performed by the inventors of the present application.

### DETAILED DESCRIPTION

To date, technologies for improving security in in-vehicle networks have been developed.

### Problems to be Solved by the Present Disclosure

Beyond the technologies described in PATENT LITERATURE 1 and PATENT LITERATURE 2, there is a demand for a technology capable of more accurately detecting an unauthorized message in an in-vehicle network.

The present disclosure has been made to solve the above problem, and an object of the present disclosure is to provide a detection device, a vehicle, a detection method, and a detection program capable of more accurately detecting an unauthorized message in an in-vehicle network.

### Effects of the Present Disclosure

According to the present disclosure, it is possible to more accurately detect an unauthorized message in an in-vehicle network.

### Description of Embodiment of the Present Disclosure

First, contents of embodiments of the present invention will be listed and described.

(1) A detection device according to an embodiment of the present disclosure is a detection device that detects an unauthorized message in an in-vehicle network. The detection device includes: an acquisition unit configured to acquire a target distribution that is a distribution of reception intervals of periodic messages transmitted in the in-vehicle network; an extraction unit configured to extract a part of the target distribution acquired by the acquisition unit, in accordance with a predetermined criterion; and a detection unit configured to perform a detection process of detecting an unauthorized message, based on the part, of the target distribution, extracted by the extraction unit.

In the above configuration, a part of the target distribution is extracted according to the predetermined criterion, and an unauthorized message is detected based on the extracted part of the target distribution. Therefore, for example, a part, in which characteristics, such as a clock frequency, of the in-vehicle device as a transmission source are reflected, can be extracted from the target distribution, and whether or not the in-vehicle device as the transmission source is an unauthorized in-vehicle device can be identified based on the extracted part. Therefore, it is possible to more accurately detect an unauthorized message in the in-vehicle network.

(2) Preferably, the extraction unit extracts the part of the target distribution by using a reference distribution that is a distribution of the reception intervals of the periodic messages being transmitted under a situation where a predetermined condition is satisfied.

In the above configuration, for example, a part, in which characteristics, such as a clock frequency, of the in-vehicle device as a transmission source are strongly reflected, can be extracted from the target distribution by using the reference distribution with the designated condition. Therefore, it is possible to more accurately detect an unauthorized message.

(3) More specifically, the predetermined condition is that a utilization rate of the in-vehicle network is lower than a utilization rate of the in-vehicle network when the target distribution is acquired.

In the above configuration, by using the reference distribution in which influence such as transmission delay of periodic messages according to the utilization rate of the in-vehicle network has been reduced, a part, in which influence according to the utilization rate of the in-vehicle network is relatively small, can be extracted from the target distribution. Therefore, it is possible to more accurately detect an unauthorized message.

(4) Preferably, the detection unit performs the detection process, based on a standard deviation of the reception intervals of the periodic messages in the part of the target distribution.

The calculation load when calculating the standard deviation of the reception intervals of the periodic messages in the part of the target distribution is smaller than the calculation load when calculating the number of peaks or the kurtosis in the part of the target distribution. Therefore, the above configuration allows the detection process to be performed through a simple calculation process on the target distribution.

(5) Preferably, the detection unit performs the detection process, based on the number of peaks in the part of the target distribution.

The calculation load when calculating the number of peaks in the part of the target distribution is smaller than the calculation load when calculating the kurtosis in the part of the target distribution. Therefore, the above configuration allows the detection process which is hard to avoid to be performed through a relatively simple arithmetic operation on the target distribution.

(6) Preferably, the detection unit performs the detection process, based on a kurtosis of the part of the target distribution.

The above configuration realizes the detection process which is hard to avoid.

(7) Preferably, the detection device further includes a calculation unit configured to calculate a statistic of the reception intervals of the periodic messages, based on the target distribution acquired by the acquisition unit. The detection unit performs the detection process, based on a result of comparison of the statistic calculated by the calculation unit with a predetermined value.

In the above configuration, for example, a variety of detection processes can be performed based on a statistic reflecting an error between an actual transmission cycle and a design transmission cycle, in the in-vehicle device as the transmission source.

(8) A vehicle according to the embodiment of the present disclosure includes the above detection device.

In the above configuration, an unauthorized message in the in-vehicle network can be more accurately detected in the vehicle including the detection device.

(9) A detection method according to the embodiment of the present disclosure is a detection method performed by a detection device that detects an unauthorized message in an in-vehicle network. The method includes: acquiring a target distribution that is a distribution of reception intervals of periodic messages transmitted in the in-vehicle network; extracting a part of the acquired target distribution in accordance with a predetermined criterion; and performing a detection process of detecting an unauthorized message, based on the extracted part of the target distribution.

In the above method, a part of the target distribution is extracted according to the predetermined criterion, and an unauthorized message is detected based on the extracted part of the target distribution. Therefore, for example, a part, in which characteristics, such as a clock frequency, of the in-vehicle device as a transmission source are reflected, can be extracted from the target distribution, and whether or not the in-vehicle device as the transmission source is an unauthorized in-vehicle device can be identified based on the extracted part. Therefore, it is possible to more accurately detect an unauthorized message in the in-vehicle network.

(10) A detection program according to the embodiment of the present disclosure is a detection program used in a detection device that detects an unauthorized message in an in-vehicle network. The detection program causes a computer to function as: an acquisition unit configured to acquire a target distribution that is a distribution of reception intervals of periodic messages transmitted in the in-vehicle network; an extraction unit configured to extract a part of the target distribution acquired by the acquisition unit, in accordance with a predetermined criterion; and a detection unit configured to perform a detection process of detecting an unauthorized message, based on the part, of the target distribution, extracted by the extraction unit.

In the above configuration, a part of the target distribution is extracted according to the predetermined criterion, and an unauthorized message is detected based on the extracted part of the target distribution. Therefore, for example, a part, in which characteristics, such as a clock frequency, of the in-vehicle device as a transmission source are reflected, can be extracted from the target distribution, and whether or not the in-vehicle device as the transmission source is an unauthorized in-vehicle device can be identified based on the extracted part. Therefore, it is possible to more accurately detect an unauthorized message in the in-vehicle network.

Hereinafter, an embodiment of the present disclosure will be described with reference to the drawings. In the drawings, the same or corresponding parts are denoted by the same reference signs, and description thereof is not repeated. At least some parts of the embodiment described below may be combined as desired.

### Configuration and Basic Operation

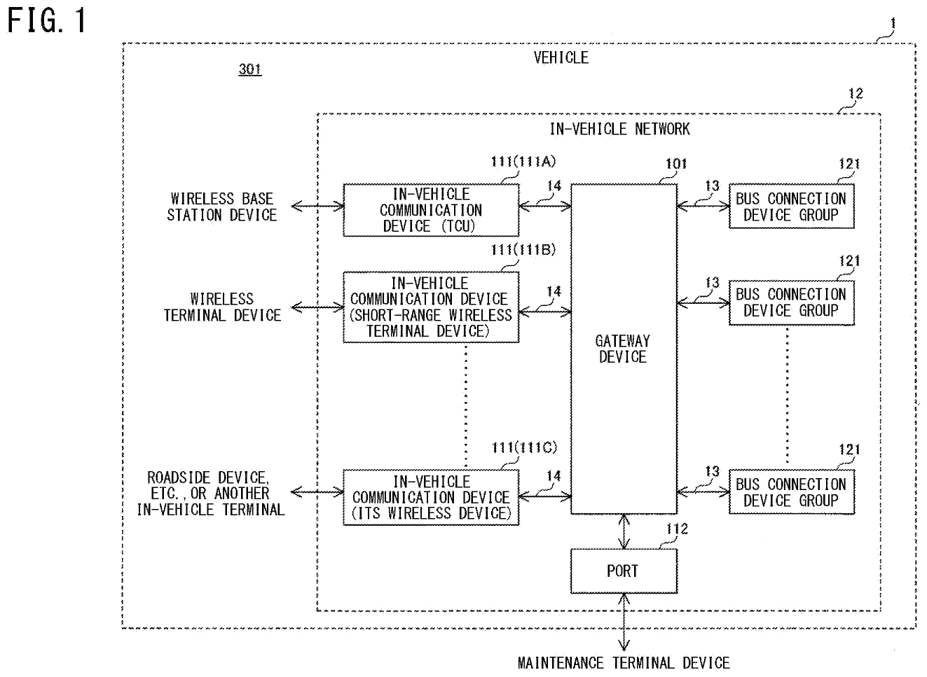

FIG. 1 shows a configuration of an in-vehicle communication system according to an embodiment of the present disclosure.

With reference to FIG. 1, an in-vehicle communication system 301 includes a gateway device 101, a plurality of in-vehicle communication devices 111, and a plurality of bus connection device groups 121. The in-vehicle communication system 301 is mounted in a vehicle 1.

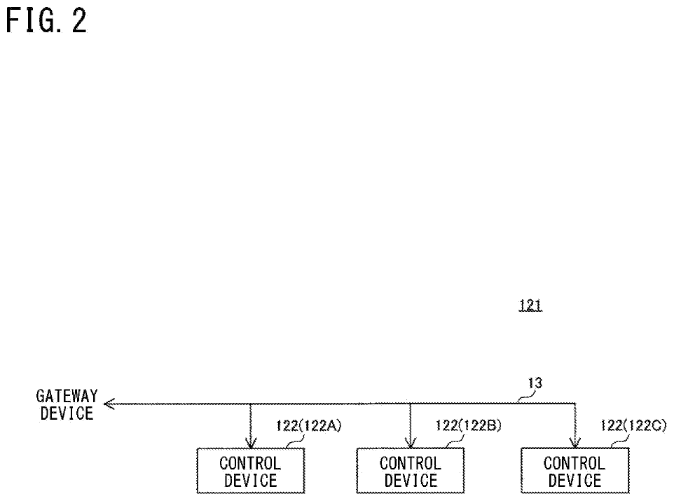

FIG. 2 shows a configuration of a bus connection device group according to the embodiment of the present disclosure.

With reference to FIG. 2, the bus connection device group 121 includes control devices 122A, 122B, 122C. Hereinafter, each of the control devices 122A, 122B, 122C is also referred to as a control device 122. The bus connection device group 121 may not necessarily include three control devices 122, and may include one, two, four, or more control devices 122.

The in-vehicle network 12 includes a gateway device 101, a plurality of in-vehicle communication devices 111, and a plurality of control devices 122, which are examples of in-vehicle devices. The in-vehicle network 12 may include a plurality of in-vehicle communication devices 111 while including no control device 122. The in-vehicle network 12 may include a plurality of control devices 122 while including no in-vehicle communication device 111. The in-vehicle network 12 may include one in-vehicle communication device 111 and one control device 122.

In the in-vehicle network 12, the in-vehicle communication device 111 communicates with a device outside the vehicle 1, for example. Specifically, the in-vehicle communication device 111 is a TCU (Telematics Communication Unit) 111A, a short-range wireless terminal device 111B, or an ITS (Intelligent Transport Systems) wireless device 111C, for example.

The TCU 111A can perform wireless communication with a wireless base station device in accordance with a communication standard such as LTE (Long Term Evolution) or 3G, for example, and can perform communication with the gateway device 101. The TCU 111A relays information to be used in services such as navigation, vehicle burglar prevention, remote maintenance, and FOTA (Firmware Over The Air), for example.

The short-range wireless terminal device 111B can perform wireless communication with a wireless terminal device such as a smartphone held by a person in the vehicle 1, i.e., an occupant, in accordance with a communication standard such as Wi-Fi (registered trademark) and Bluetooth (registered trademark), for example, and can perform communication with the gateway device 101. The short-range wireless terminal device 111B relays information to be used in a service such as entertainment, for example.

For example, the short-range wireless terminal device 111B can perform wireless communication with a wireless terminal device such as a smart key held by the occupant and with a wireless terminal device provided to a tire, in accordance with a predetermined communication standard, by using a radio wave in an LF (Low Frequency) band or a UHF (Ultra High Frequency) band, and can perform communication with the gateway device 101. The short-range wireless terminal device 111B relays information to be used in services such as smart entry and TPMS (Tire Pressure Monitoring System), for example.

The ITS wireless device 111C can perform roadside-to-vehicle communication with a roadside device, such as an optical beacon, a radio wave beacon, or an ITS spot, provided in the vicinity of a road, can perform vehicle-to-vehicle communication with an in-vehicle terminal mounted in another vehicle, and can perform communication with the gateway device 101, for example. The ITS wireless device 111C relays information to be used in services such as congestion alleviation, safe driving support, and route guidance, for example.

The gateway device 101 can, via a port 112, transmit/receive data for update or the like of firmware, and data, etc., accumulated by the gateway device 101 to/from a maintenance terminal device outside the vehicle 1, for example.

The gateway device 101 is connected to another in-vehicle device in the in-vehicle network 12 via buses 13, 14, for example. Specifically, each bus 13, 14 is a bus according to, for example, a standard of CAN (Controller Area Network) (registered trademark), FlexRay (registered trademark), MOST (Media Oriented Systems Transport) (registered trademark), Ethernet (registered trademark), LIN (Local Interconnect Network), or the like.

In this example, each in-vehicle communication device 111 is connected to the gateway device 101 via a corresponding bus 14 according to the Ethernet standard. Meanwhile, each control device 122 in the bus connection device group 121 is connected to the gateway device 101 via a corresponding bus 13 according to the CAN standard.

The buses 13 are provided for different types of systems, for example. Specifically, the buses 13 are implemented as a drive-related bus, a chassis/safety-related bus, a body/electrical-equipment-related bus, and an AV/information-related bus, for example.

An engine control device, an AT (Automatic Transmission) control device, and an HEV (Hybrid Electric Vehicle) control device, which are examples of the control device 122, are connected to the drive-related bus. The engine control device, the AT control device, and the HEV control device control an engine, AT, and switching between the engine and a motor, respectively.

A brake control device, a chassis control device, and a steering control device, which are examples of the control device 122, are connected to the chassis/safety-related bus. The brake control device, the chassis control device, and the steering control device control a brake, a chassis, and steering, respectively.

An instrument indication control device, an air conditioner control device, a burglar prevention control device, an air bag control device, and a smart entry control device, which are examples of the control device 122, are connected to the body/electrical-equipment-related bus. The instrument indication control device, the air conditioner control device, the burglar prevention control device, the air bag control device, and the smart entry control device control instruments, an air conditioner, a burglar prevention mechanism, an air bag mechanism, and smart entry, respectively.

A navigation control device, an audio control device, an ETC (Electronic Toll Collection System) (registered trademark) control device, and a telephone control device, which are examples of the control device 122, are connected to the AV/information-related bus. The navigation control device, the audio control device, the ETC control device, and the telephone control device control a navigation device, an audio device, an ETC device, and a mobile phone, respectively.

The bus 13 may not necessarily have the control devices 122 connected thereto, and may have connected thereto a device other than the control device 122.

The gateway device 101 is a central gateway (CGW), for example, and can perform communication with another in-vehicle device.

The gateway device 101 performs a relay process of relaying information transmitted/received between control devices 122 that are connected to different buses 13 in the vehicle 1, information transmitted/received between in-vehicle communication devices 111, and information transmitted/received between a control device 122 and an in-vehicle communication device 111, for example.

More specifically, in the vehicle 1, for example, a message is periodically transmitted from an in-vehicle device to another in-vehicle device in accordance with a predetermined rule. In this example, a message periodically transmitted from a control device 122 to another control device 122 is described. However, the same also applies to a message that is transmitted between a control device 122 and an in-vehicle communication device 111, and a message that is transmitted between in-vehicle communication devices 111.

Transmission of a message may be performed by broadcast or may be performed by unicast. Hereinafter, a message that is periodically transmitted is also referred to as a periodic message. The “periodic message” refers not only to a message that is strictly periodically transmitted but also a kind of a message that is to be periodically transmitted.

In the vehicle 1, in addition to the periodic message, a message that is non-periodically transmitted from a control device 122 to another control device 122 exists. Each message includes a message number, and an ID (Identifier) for identifying the content and a transmission source of the message. Whether or not a message is a periodic message can be identified by the ID included in the message.

[Configuration of Gateway Device]

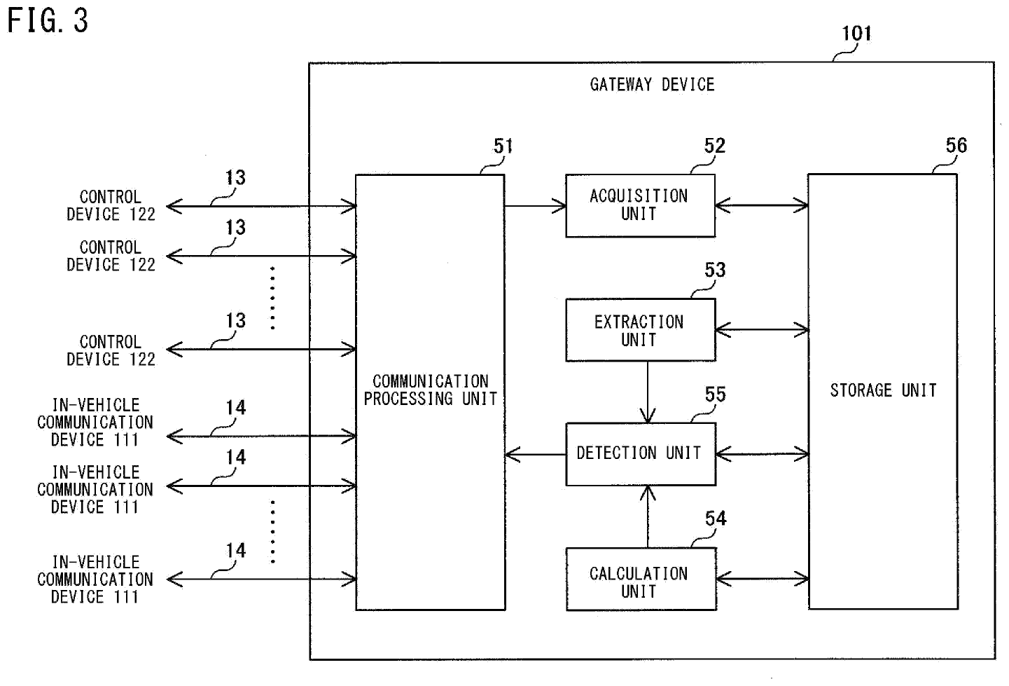

FIG. 3 shows a configuration of the gateway device in the in-vehicle communication system according to the embodiment of the present disclosure.

With reference to FIG. 3, the gateway device 101 includes a communication processing unit 51, an acquisition unit 52, an extraction unit 53, a calculation unit 54, a detection unit 55, and a storage unit 56.

The communication processing unit 51, the acquisition unit 52, the extraction unit 53, the calculation unit 54, and the detection unit 55 are realized by a processor such as a CPU (Central Processing Unit) or a DSP (Digital Signal Processor), for example. The storage unit 56 is a flash memory, for example.

The gateway device 101 functions as a detection device, and performs a detection process of detecting an unauthorized message in the in-vehicle network 12.

[Communication Processing Unit]

The communication processing unit 51 performs a relay process of relaying a message transmitted between control devices 122, a message transmitted between in-vehicle communication devices 111, and a message transmitted between a control device 122 and an in-vehicle communication device 111.

For example, upon receiving a message from a certain control device 122 via a corresponding bus 13, the communication processing unit 51 attaches, to the received message, a time stamp indicating the reception time of the message. Then, the communication processing unit 51 transmits the message with the time stamp, to another control device 122 via a corresponding bus 13.

[Acquisition Unit]

The acquisition unit 52 acquires a target distribution that is a distribution of reception intervals of periodic messages transmitted in the in-vehicle network 12.

For example, the acquisition unit 52 monitors messages relayed by the communication processing unit 51, and acquires a reception time t of a periodic message to be subjected to the detection process in the gateway device 101. Hereinafter, a periodic message to be subjected to the detection process in the gateway device 101 is also referred to as a target message.

The target message may be one type of periodic message transmitted from a certain control device 122, or may be a plurality of types of periodic messages respectively transmitted from the plurality of control devices 122. Hereinafter, a description will be given of a case where the gateway device 101 performs the detection process with a periodic message transmitted from the control device 122A being a “target message M”.

For example, the storage unit 56 has, stored therein, an ID for each type of target message. Hereinafter, an ID of a target message M is also referred to as a target ID.

When the communication processing unit 51 has received a message to be subjected to the relay process, the acquisition unit 52 confirms the ID included in the message received by the communication processing unit 51 and the target ID stored in the storage unit 56.

When the ID included in the message received by the communication processing unit 51 matches the target ID, the acquisition unit 52 recognizes that the message received by the communication processing unit 51 is a target message M, and acquires a reception time t of the target message M with reference to a time stamp attached to the target message M.

Upon acquiring the reception time t of the target message M, the acquisition unit 52 calculates a difference between this reception time t and a reception time t of an immediately preceding target message M, as a reception interval x of the target messages M.

More specifically, the acquisition unit 52 calculates a difference between a reception time to of an n-th target message Mn received by the communication processing unit 51 and a reception time t(n−1) of an (n−1)th target message M(n−1) received by the communication processing unit 51, and stores the calculated difference as a reception interval xn of the target message Mn into the storage unit 56. Here, n is a positive integer.

Then, the acquisition unit 52, based on a plurality of reception intervals x stored in the storage unit 56, generates a frequency distribution D of the reception intervals x of the target messages M received by the communication processing unit 51 within a target period Ta which is a predetermined period, and stores the generated frequency distribution D in the storage unit 56. The frequency distribution D is an example of the target distribution. Hereinafter, the target messages M received by the communication processing unit 51 within the target period Ta are also referred to as “target messages M within a target period Ta”. In addition, the frequency distribution D of the reception intervals x of the target messages M received by the communication processing unit 51 within the target period Ta is also referred to as a “frequency distribution D within a target period Ta”.

For example, the acquisition unit 52 newly generates a frequency distribution D in a target period Ta starting from a time (T1×m), at a generation timing according to a cycle T1, and updates the frequency distribution D stored in the storage unit 56 to the newly generated frequency distribution D. Here, m is a positive integer.

The cycle T1 being equal to the target period Ta may cause the respective target periods Ta to be temporally continuous. The cycle T1 being shorter than the target period Ta may cause the respective target periods Ta to temporally and partially overlap each other. The cycle T1 being longer than target period Ta may cause the respective target periods Ta to be intermittent.

[Extraction Unit]

The extraction unit 53 extracts, according to a predetermined criterion, a part of the target distribution acquired by the acquisition unit 52.

For example, the extraction unit 53 generates a probability density function that approximates the frequency distribution D stored in the storage unit 56, by using a Gaussian mixture model. Then, the extraction unit 53 extracts a part of the generated probability density function in accordance with a predetermined criterion.

(Approximation by Probability Density Function)

For example, the extraction unit 53 approximates the frequency distribution D stored in the storage unit 56 by using a probability density function P which is shown in Expression (1) below and has x as a variable.

[Math. 1]

$$P ( x \vert {c}_{k} , {\overline{x}}_{k} , {σ}_{k}^{2} ) = {\sum }_{1}^{K} {c}_{k} p ( x \vert {\overline{x}}_{k} , {σ}_{k}^{2} ) \qquad ( 1 )$$

Here, K, ck, xk-bar, and σk\hat{ }2 are parameters, and respectively indicate the number of mixed normal distributions, the mixture ratio of a k-th normal distribution function p, the average of the k-th normal distribution, and variance of the k-th normal distribution. Here, k is an integer in the range of 1 to K. In addition, “a\hat{ }b” means “a to the power of b”.

The k-th normal distribution function p in Expression (1) is represented by the following Expression (2).

[Math. 2]

$$p ( x \vert {\overline{x}}_{k} , {σ}_{k}^{2} ) = \frac{1}{\sqrt{2 π {σ}_{k}^{2}}} exp \{ - \frac{{( x - \overline{x} )}^{2}}{2 {σ}^{2}} \} \qquad ( 2 )$$

For example, each time the frequency distribution D stored in the storage unit 56 is updated by the acquisition unit 52, the extraction unit 53 updates cl to cK, xl-bar to xK-bar, and σ1\hat{ }2 to σK\hat{ }2 in the probability density function P, by using a Stepwise-EM method described in NON-PATENT LITERATURE 1 (O. Cappe, one other, “Online expectation maximization algorithm for latent data models”, Journal od the Royal Statistics Society: Series B (Statistical Methodology), Vol. 71, P. 593-613, 2009).

More specifically, in an E step and an M step, the extraction unit 53 applies the Stepwise-EM method to each of i (=1 to K) to calculate ci, xi-bar, and σi\hat{ }2.

Specifically, in the E step, the extraction unit 53 calculates an attenuation coefficient ηt by using the following Expression (3).

[Math. 3]

ηt=(m)^{-α} (3)

In addition, the extraction unit 53 calculates an i-th burden ratio γi(s) by using the following Expression (4).

[Math. 4]

$${γ}_{i}^{( s )} = \frac{{c}_{i}^{( s - 1 )} p ( {y}_{u} )}{{\sum }_{i = 1}^{K} {c}_{i}^{s - 1} p ( {y}_{u} )} \qquad ( 4 )$$

The extraction unit 53 calculates a sufficient statistic Si(s) and an updated sufficient statistic S(s) by using the following Expressions (5) and (6), respectively.

[Math. 5]

sₜ^{(s)}=(γᵢ^{(s)},γᵢ^{(s)}·yᵤ,γᵢ^{(s)}·yᵤyᵤ^{T}) (5)

[Math. 6]

s^{(s)}=(1−ηₜ)s^{(s-1)}+ηₜsᵢ^{(s)} (6)

Here, s(s−1) is a sufficient statistic in the previous E step.

In the M step, the extraction unit 53 calculates an i-th mixture ratio ci(s), an i-th average xi-bar(s), and an i-th variance σi\hat{ }2(s) by using the following Expressions (7), (8), and (9).

[Math. 7]

cᵢ^{(s)}=γᵢ^{(s)} (7)

[Math. 8]

$${\overline{x}}_{i}^{( s )} = \frac{{γ}_{i}^{( s )} \cdot {y}_{u}}{{c}_{i}^{( s )}} \qquad ( 8 )$$

[Math. 9]

$${σ}_{i}^{{2}^{( s )}} = \frac{{γ}_{i}^{( s )} \cdot {y}_{u} {y}_{u}^{T}}{{c}_{i}^{( s )}} + {\overline{x}}_{i}^{( s )} {\overline{x}}_{i}^{{( s )}^{T}} \qquad ( 9 )$$

Then, the extraction unit 53 increments the number of calculation operations w by using the following Expression (10).

[Math. 10]

w=w+1 (10)

Through the above calculation processing, the extraction unit 53 generates the probability density function P that approximates the frequency distribution D in the target period Ta. Hereinafter, the probability density function P that approximates the frequency distribution D is also referred to as a “probability density function P based on a frequency distribution D”.

(Extraction of Part of Probability Density Function)

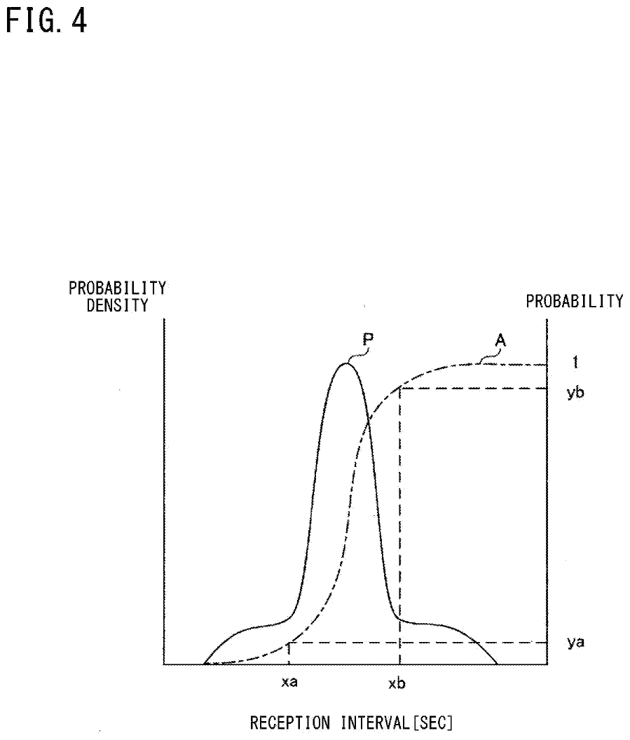

FIG. 4 shows examples of a probability density function and a cumulative distribution function generated by the extraction unit in the gateway device according to the embodiment of the present disclosure. In FIG. 4, a solid line indicates a probability density function P, and an alternate long and short dash line indicates a cumulative distribution function A. In addition, in FIG. 4, the horizontal axis indicates reception interval x[sec], the vertical axis with respect to the probability density function P indicates probability density, and the vertical axis with respect to the cumulative distribution function A indicates probability.

With reference to FIG. 4, the extraction unit 53 obtains a definite integral of the generated probability density function P to generate the cumulative distribution function A.

For example, the extraction unit 53 extracts, from the frequency distribution D, a distribution within a range of values of the reception interval x when the values of probability in the generated cumulative distribution function A are within a predetermined range.

More specifically, the extraction unit 53 determines, as an extraction section, a range of values of the reception interval x when the values of probability represented by the generated cumulative distribution function A are within a predetermined range, and extracts a part of the probability density function P, based on the determined extraction section.

For example, the storage unit 56 has, stored therein, a predetermined value ya as a lower limit value and a predetermined value yb as an upper limit value in the predetermined range of the probability represented by the cumulative distribution function A.

When the extraction unit 53 has generated the cumulative distribution function A, the extraction unit 53, based on the generated cumulative distribution function A and the predetermined values ya, yb stored in the storage unit 56, specifies a reception interval xa at which the probability represented by the cumulative distribution function A becomes the predetermined value ya, and a reception interval xb at which the probability represented by the cumulative distribution function A becomes the predetermined value yb.

Then, the extraction unit 53 determines, as an extraction section [xa, xb], a range in which the reception interval x is not smaller than xa and not greater than xb, and extracts the probability density function P in the extraction section [xa, xb].

For example, the extraction unit 53 outputs, to the detection unit 55, extraction information including: K, cl to cK, xl-bar to xK-bar, and σ1\hat{ }2 to σK\hat{ }2 in the probability density function P based on the frequency distribution D in the target period Ta; and the determined extraction section [xa, xb].

(Setting of Predetermined Values Ya, Yb)

For example, the extraction unit 53 extracts a part of the frequency distribution D by using a reference distribution that is a distribution of reception intervals x of periodic messages transmitted under a situation where a predetermined condition is satisfied.

For example, the predetermined condition is that the utilization rate of the in-vehicle network 12 is lower than the utilization rate of the in-vehicle network 12 when the frequency distribution D of the reception intervals x of the target messages M is acquired.

Since the utilization rate of the in-vehicle network 12 in the vehicle 1 being used is generally about 40%, the utilization rate of the in-vehicle network 12 when the frequency distribution D of the reception intervals x of the target messages M is acquired is also about 40%.

Therefore, the extraction unit 53 extracts a part of the probability density function P by using the frequency distribution of the periodic messages transmitted under the situation where the utilization rate of the in-vehicle network 12 is 0%.

More specifically, the predetermined values ya, yb stored in the storage unit 56 have been determined in advance by using a frequency distribution D (UR0) of reception intervals x, in the gateway device 101, of periodic messages transmitted from the control device 122A under the situation where the utilization rate of the in-vehicle network 12 is 0%. The frequency distribution D (UR0) is an example of the reference distribution.

The extraction unit 53 determines the extraction section [xa, xb] of the probability density function P by using the predetermined values ya, yb having been determined in advance by using the frequency distribution D(UR0).

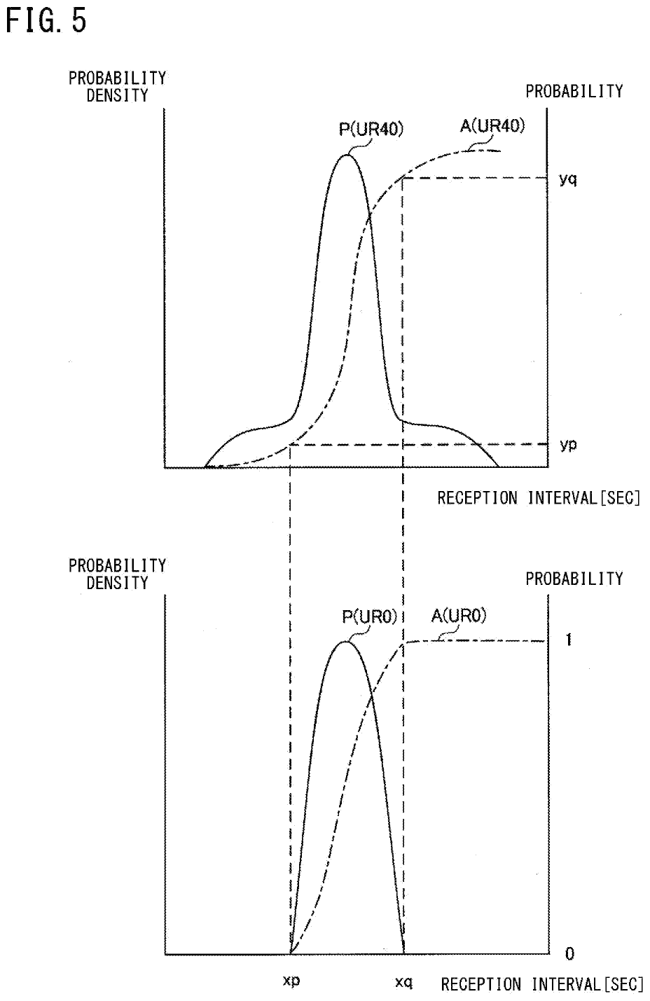

FIG. 5 shows examples of a probability density function and a cumulative distribution function generated by the extraction unit in the gateway device according to the embodiment of the present disclosure. In FIG. 5, a solid line indicates a probability density function P, and an alternate long and short dash line indicates a cumulative distribution function A. In addition, in FIG. 5, the horizontal axis indicates reception interval x [sec], the vertical axis with respect to the probability density function P indicates probability density, and the vertical axis with respect to the cumulative distribution function A indicates probability.

With reference to FIG. 5, for example, the acquisition unit 52 generates a frequency distribution D (UR0) of reception intervals x of periodic messages transmitted from the control device 122A, under the situation where the utilization rate of the in-vehicle network 12 has been set to 0% by an operator in a manufacturing factory or the like of the vehicle 1 before shipment of the vehicle 1.

Likewise, the acquisition unit 52 generates a frequency distribution D(UR40) of reception intervals x of periodic messages transmitted from the control device 122A, under the situation where the utilization rate of the in-vehicle network 12 has been set to 40% by the operator in the manufacturing factory or the like of the vehicle 1. It is assumed that no unauthorized message is included in the periodic messages transmitted from the control device 122A when the acquisition unit 52 generates the frequency distributions D(UR0), D(UR40).

The extraction unit 53 generates a probability density function P(UR0) that approximates the frequency distribution D(UR0) generated by the acquisition unit 52, and a cumulative distribution function A(UR0). Moreover, the extraction unit 53 generates a probability density function P(UR40) that approximates the frequency distribution D(UR40) generated by the acquisition unit 52, and a cumulative distribution function A(UR40).

Next, the extraction unit 53 specifies a reception interval xp when the probability represented by the cumulative distribution function A(UR0) is 0, and a reception interval xq when the probability represented by the cumulative distribution function A(UR0) reaches 1.

Next, the extraction unit 53 specifies a probability yp corresponding to the reception interval xp and a probability yq corresponding to the reception interval xq in the cumulative distribution function A(UR40), and stores the probability yp and the probability yq as a predetermined value ya and a predetermined value yb into the storage unit 56, respectively.

As described above, each time the acquisition unit 52 generates a frequency distribution D in a target period Ta, the extraction unit 53 generates a probability density function P and generates a cumulative distribution function A by obtaining a definite integral of the generated probability density function P. Then, the extraction unit 53 determines an extraction section [xa, xb], based on the generated cumulative distribution function A and the values ya, yb predetermined as described above, and extracts the probability density function P in the determined extraction section [xa, xb].

[Calculation Unit]

The calculation unit 54 calculates a statistic of reception intervals of periodic messages, based on the frequency distribution D acquired by the acquisition unit 52.

When the frequency distribution D stored in the storage unit 56 is updated by the acquisition unit 52, the calculation unit 54 calculates an average Av of a plurality of reception intervals x constituting the updated frequency distribution D. Then, the calculation unit 54 outputs the calculated average Av to the detection unit 55.

[Detection Unit]

The detection unit 55 performs a detection process of detecting an unauthorized message, based on a part, of a target distribution, extracted by the extraction unit 53.

More specifically, upon receiving the extraction information from the extraction unit 53, the detection unit 55 performs the detection process, based on the received extraction information.

(First Example of Detection Process)

The detection unit 55 performs the detection process, based on a standard deviation of reception intervals x of periodic messages in the part of the target distribution.

More specifically, upon receiving the extraction information from the extraction unit 53, the detection unit 55, with reference to the storage unit 56, extracts reception intervals x in the range of the extraction section [xa, xb] indicated by the extraction information received from the extraction unit 53, from among the plurality of reception intervals x constituting the frequency distribution D in the target period Ta, and calculates a standard deviation Sd of the extracted reception intervals x.

For example, the storage unit 56 has, stored therein, thresholds ThA, ThB regarding the standard deviation Sd. It is assumed that the threshold ThA is smaller than the threshold ThB.

When the detection unit 55 has calculated the standard deviation Sd, the detection unit 55 compares the calculated standard deviation Sd with the thresholds ThA, ThB stored in the storage unit 56, and detects an unauthorized message, based on the comparison result. For example, if the standard deviation Sd is smaller than the threshold ThA or greater than the threshold ThB, the detection unit 55 determines that some or all of the target messages M in the target period Ta are unauthorized messages.

For example, the detection unit 55 performs the detection process by using a control chart such as a Shewhart control chart, an Xbar-R control chart, a CUSUM (Cumulative Sum) control chart, an EWMA (Exponentially Weighted Moving Average) control chart, a MEWMA (Multivariate Exponentially Weighted Moving Average) control chart, or a MEWMC (Multivariate Exponentially Weighted Moving Covariance Matrix) control chart, for example.

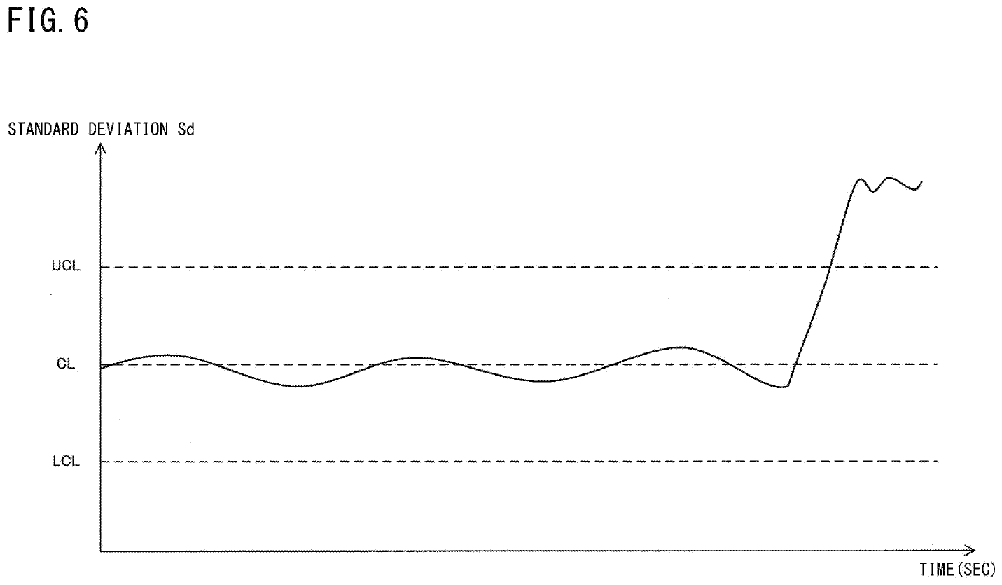

FIG. 6 shows change over time of the standard deviation calculated by the detection unit in the gateway device according to the embodiment of the present disclosure. In FIG. 6, the horizontal axis indicates time [sec], and the vertical axis indicates standard deviation Sd.

With reference to FIG. 6, the detection unit 55 monitors change over time of the standard deviation Sd calculated for each target period Ta. The detection unit 55 determines that some or all of the target messages M in the target period Ta are unauthorized messages when the standard deviation Sd exceeds an upper control limit line UCL, when the standard deviation Sd falls below a lower control limit line LCL, when the standard deviation Sd exceeds a center line CL continuously for a fixed time, or when the standard deviation Sd falls below the center line CL continuously for a fixed time.

For example, the lower control limit line LCL is the threshold ThA in the storage unit 56, and the upper control limit line UCL is the threshold ThB in the storage unit 56.

(Second Example of Detection Process)

The detection unit 55 performs the detection process, based on the number of peaks in the part of the target distribution.

More specifically, with respect to the probability density function P based on K, cl to cK, xl-bar to xK-bar, and σ1\hat{ }2 to σK\hat{ }2 included in the extraction information received from the extraction unit 53, the detection unit 55 calculates a number Ps of peaks existing in the extraction section [xa, xb] indicated by the extraction information.

For example, the storage unit 56 has, stored therein, a threshold ThC regarding the number Ps of peaks.

When the detection unit 55 has calculated the number Ps of peaks, the detection unit 55 compares the calculated number Ps of peaks with the threshold ThC stored in the storage unit 56, and detects an unauthorized message, based on the comparison result. For example, the detection unit 55 determines that some or all of the target messages M in the target period Ta are unauthorized messages when the number Ps of peaks is greater than the threshold ThC.

(Third Example of Detection Process)

The detection unit 55 performs the detection process, based on a kurtosis in the part of the target distribution.

More specifically, with respect to the probability density function P based on K, cl to cK, xl-bar to xK-bar, and σ1\hat{ }2 to σK\hat{ }2 included in the extraction information received from the extraction unit 53, the detection unit 55 calculates a kurtosis Ks of peaks existing in the extraction section [xa, xb] indicated by the extraction information.

For example, the storage unit 56 has, stored therein, a threshold ThD regarding the kurtosis Ks.

When the detection unit 55 has calculated a kurtosis Ks of peaks, the detection unit 55 compares the calculated kurtosis Ks with the threshold ThD stored in the storage unit 56, and detects an unauthorized message, based on the comparison result. For example, the detection unit 55 determines that some or all of the target messages M in the target period Ta are unauthorized messages when the kurtosis Ks is smaller than the threshold ThD.

(Fourth Example of Detection Process)

The detection unit 55 performs the detection process, based on a result of comparison of a statistic such as an average Av calculated by the calculation unit 54 with a predetermined value.

For example, the storage unit 56 has, stored therein, thresholds ThE, ThF regarding the average Av of reception intervals x. It is assumed that the threshold ThE is smaller than the threshold ThF.

Upon receiving the average Av from the calculation unit 54, the detection unit 55 compares the received average Av with the thresholds ThE, ThF stored in the storage unit 56, and detects an unauthorized message, based on the comparison result. For example, the detection unit 55 determines that some or all of the target messages M in the target period Ta are unauthorized messages when the average Av is smaller than the threshold ThE or greater than the threshold ThF.

In the second to fourth examples of the detection process, the detection unit 55 may perform the detection process by using the control chart as in the first example of the detection process.

Meanwhile, the detection unit 55 may calculate a score indicating the degree of abnormality of a target message M by using some or all of: the standard deviation Sd of reception intervals x, the number Ps of peaks, the kurtosis Ks of the peaks, and the average Av of the reception intervals x, and may perform the detection process, based on change over time of the calculated score by using a control chart.

When the detection unit 55 has determined that some or all of the target messages M in the target period Ta are unauthorized messages, the detection unit 55 performs the following process.

That is, the detection unit 55 records information on the target messages M transmitted within the target period Ta. In addition, the detection unit 55 transmits, to a higher-order device inside or outside the vehicle 1 via the communication processing unit 51, alarm information indicating that an unauthorized message is being transmitted in the in-vehicle network 12. The higher-order device is a device, such as a server, that performs a predetermined process by using the alarm information.

[Operation Flow]

Each device in the in-vehicle communication system according to the embodiment of the present disclosure is provided with a computer including a memory. An arithmetic processing unit such as a CPU in the computer reads out, from the memory, a program including a part or all of the steps in the flowchart and sequence below, and executes the program. Programs for the plurality of devices can be installed from the outside. The programs for the plurality of devices are each distributed in a state of being stored in a storage medium.

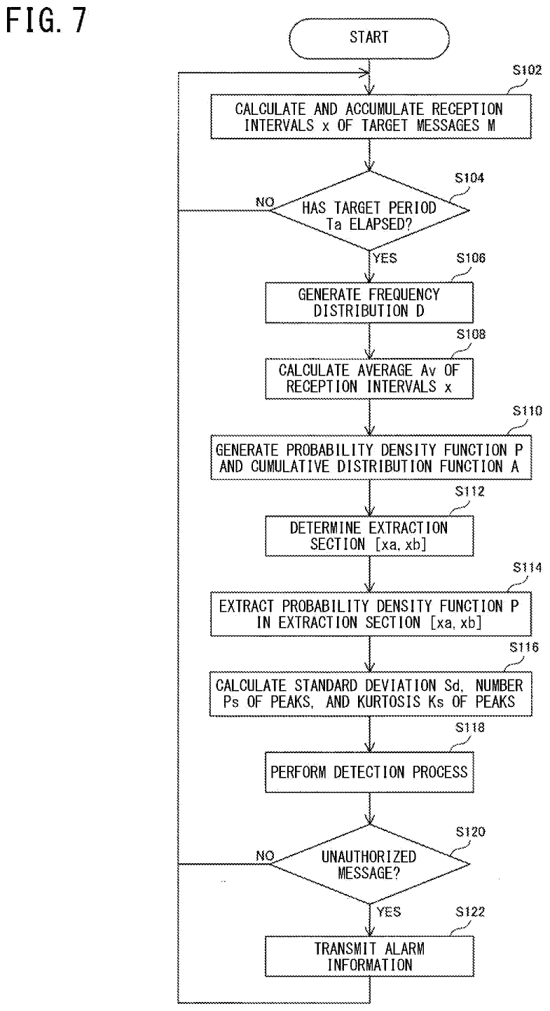

FIG. 7 is a flowchart describing an example of an operation procedure along which the gateway device performs the detection process in the in-vehicle communication system according to the present disclosure.

With reference to FIG. 7, first, the gateway device 101 monitors messages being transmitted in the in-vehicle network 12. Upon receiving a target message M, the gateway device 101 calculates a reception interval x of target messages M, based on a reception time t of the received target message M, and accumulates the calculated reception interval x in the storage unit 56 (step S102).

Next, the gateway device 101 repeats accumulation of reception intervals x until a target period Ta elapses (NO in step S104). When the target period Ta has elapsed (YES in step S104), the gateway device 101 generates a frequency distribution D of the reception intervals x of the target messages M in the target period Ta, based on the respective reception intervals x accumulated in the storage unit 56 (step S106).

Next, the gateway device 101 calculates an average Av of the reception intervals x constituting the generated frequency distribution D (step S108).

Next, the gateway device 101 generates a probability density function P that approximates the generated frequency distribution D, and subjects the generated probability density function P to definite integral to generate a cumulative distribution function A (step S110).

Next, the gateway device 101 determines an extraction section [xa, xb], based on a reception interval xa at which the probability represented by the cumulative distribution function A becomes a predetermined value ya, and a reception interval xb at which the probability represented by the cumulative distribution function A becomes a predetermined value yb (step S112).

Next, the gateway device 101 extracts a part of the frequency distribution D. More specifically, the gateway device 101 extracts the probability density function P in the extraction section [xa, xb] (step S114).

Next, the gateway device 101 calculates a standard deviation Sd, the number Ps of peaks, and a kurtosis Ks of the peaks, based on extraction information including: K, cl to cK, xl-bar to xK-bar, and σ1\hat{ }2 to σK\hat{ }2 in the extracted probability density function P; and the determined extraction section [xa, xb] (step S116).

Next, the gateway device 101 performs the detection process, based on the average Av, the standard deviation Sd, the number Ps of peaks, and the kurtosis Ks of the peaks (step S118).

Next, upon determining that the target message M in the target period Ta is not an unauthorized message as a result of the detection process (NO in step S120), the gateway device 101 receives new target messages M and accumulates the reception intervals x thereof into the storage unit 56 (step S102).

Next, upon determining that some or all of the target messages M in the target period Ta are unauthorized messages as a result of the detection process (YES in step S120), the gateway device 101 transmits, to a higher-order device inside or outside the vehicle 1, alarm information indicating that an unauthorized message is being transmitted (step S122).

Next, the gateway device 101 receives new target messages M, and accumulates the reception intervals x thereof into the storage unit 56 (step S102).

The gateway device 101 may perform the process in step S102 and the processes in steps S106 to S122 in parallel to each other.

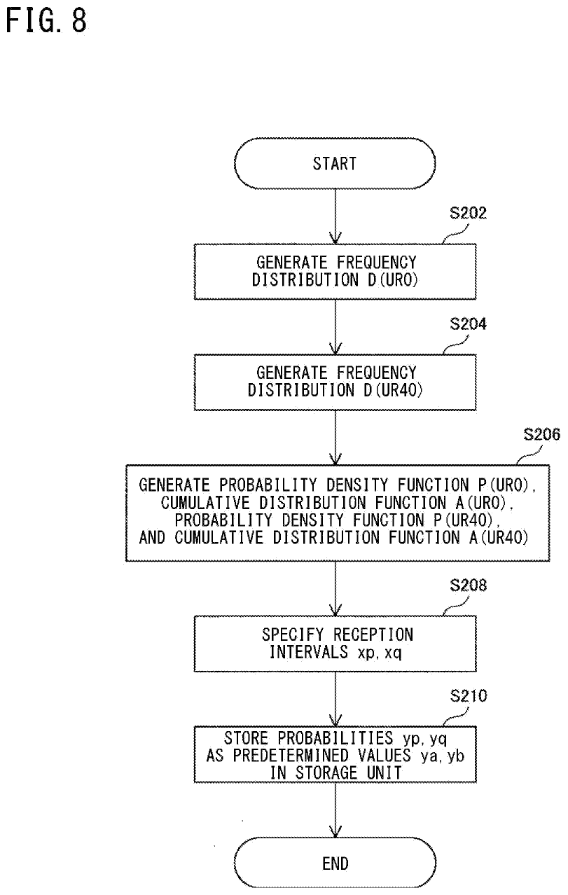

FIG. 8 is a flowchart describing an example of an operation procedure when the gateway device determines a criterion of an extraction section of the probability density function, in the in-vehicle communication system according to the embodiment of the present disclosure.

With reference to FIG. 8, first, the gateway device 101 generates a frequency distribution D(UR0) of reception intervals x of periodic messages transmitted from the control device 122A, under the situation where the utilization rate of the in-vehicle network 12 has been set to 0% by an operator in a manufacturing factory or the like of the vehicle 1 before shipment of the vehicle 1, for example (step S202).

Next, the gateway device 101 generates a frequency distribution D(UR40) of reception intervals x of periodic messages transmitted from the control device 122A, under the situation where the utilization rate of the in-vehicle network 12 has been set to 40% by the operator in the manufacturing factory or the like of the vehicle 1 (step S204).

Next, the gateway device 101 generates a probability density function P(UR0) that approximates the frequency distribution D(UR0), and a cumulative distribution function A(UR0), and generates a probability density function P(UR40) that approximates the frequency distribution D(UR40), and a cumulative distribution function A(UR40) (step S206).

Next, the gateway device 101 specifies a reception interval xp at which the probability represented by the cumulative distribution function A(UR0) is 0, and a reception interval xq at which the probability represented by the cumulative distribution function A(UR0) reaches 1 (step S208).

Next, the gateway device 101 specifies a probability yp corresponding to the reception interval xp and a probability yq corresponding to the reception interval xq in the cumulative distribution function A(UR40), and stores the probability yp and the probability yq as a predetermined value ya and a predetermined value yb, respectively, into the storage unit 56 (step S210).

In the in-vehicle communication system 301 according to the embodiment of the present disclosure, the gateway device 101 detects an unauthorized message in the in-vehicle network 12. However, the present disclosure is not limited thereto. In the in-vehicle communication system 301, a device other than the gateway device 101 may serve as a detection device to detect an unauthorized message in the in-vehicle network 12.

Moreover, in the in-vehicle communication system 301 according to the embodiment of the present disclosure, the gateway device 101 functioning as a detection device is directly connected to the bus 13. However the present disclosure is not limited thereto.

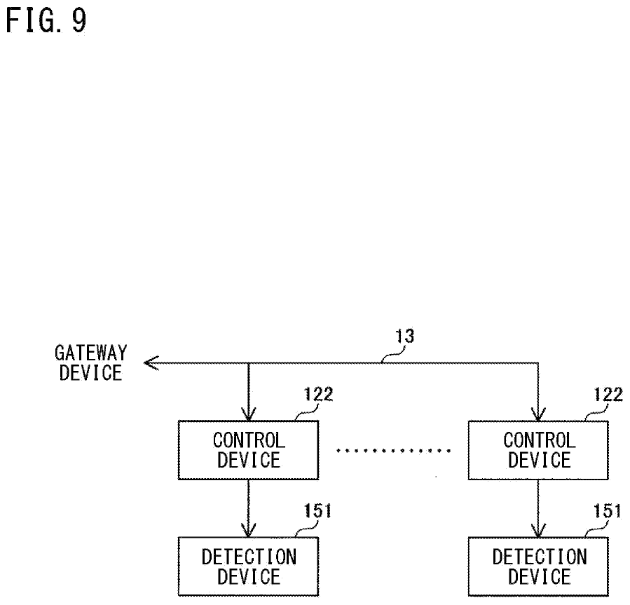

FIG. 9 shows an example of a connection topology of the in-vehicle network according to the embodiment of the present disclosure.

With reference to FIG. 9, a detection device 151 may be connected to a bus 13 via an in-vehicle device, e.g., a control device 122. In this case, for example, the detection device 151 detects an unauthorized message transmitted to the bus 13, by monitoring messages transmitted/received by the in-vehicle device.

In the example shown in FIG. 9, for example, the acquisition unit 52 of the detection device 151 acquires reception times t of target messages received by the control device 122. Then, the acquisition unit 52 calculates reception intervals x, based on the acquired reception times t, and generates a frequency distribution D of the reception intervals x.

In the gateway device 101 according to the embodiment of the present disclosure, the acquisition unit 52, which monitors messages relayed by the communication processing unit 51, acquires a reception time t of a target message M and calculates, as a reception interval x of target messages M, a difference between the acquired reception time t and a reception time t of an immediately preceding target message M. However, the present disclosure is not limited thereto. The acquisition unit 52 may receive a reception interval x from a device outside the gateway device 101 via the communication processing unit 51.

In the gateway device 101 according to the embodiment of the present disclosure, the detection unit 55 performs the detection process, based on the standard deviation Sd, the number Ps of peaks, the kurtosis Ks of the peaks, and the average Av. However, the present disclosure is not limited thereto. The detection unit 55 may perform the detection process, based on any one, two, or three of the standard deviation Sd, the number Ps of peaks, the kurtosis Ks of the peaks, and the average Av.

In the gateway device 101 according to the embodiment of the present disclosure, the detection unit 55 calculates, based on the extraction information, the standard deviation Sd, the number Ps of peaks, and the kurtosis Ks of the peaks. However, the present disclosure is not limited thereto. For example, the detection unit 55 may transmit the extraction information to an external device such as a server outside the vehicle 1, and may receive, from the external device, the standard deviation Sd, the number Ps of peaks, and the kurtosis Ks of the peaks calculated based on the transmitted extraction information.

In the gateway device 101 according to the embodiment of the present disclosure, the calculation unit 54 calculates the average Av of the reception intervals x as a statistic of the reception intervals x. However, the present disclosure is not limited thereto. The calculation unit 54 may calculate a statistic, other than the average Av, such as a median of the reception intervals x.

The gateway device 101 according to the embodiment of the present disclosure includes the calculation unit 54. However, the present disclosure is not limited thereto. The gateway device 101 may not necessarily include the calculation unit 54. In this case, the detection unit 55 performs the detection process, based on at least one of the standard deviation Sd, the number Ps of peaks, and the kurtosis Ks of the peaks.

The calculation unit 54 may be provided in an external device such as a server outside the vehicle 1. In this case, the detection unit 55 may receive, from the external device, the average Av calculated based on the frequency distribution D.

In the gateway device 101 according to the embodiment of the present disclosure, the extraction unit 53 determines the extraction section [xa, xb], based on the predetermined values ya, yb determined in advance by using the frequency distribution D(UR0) as an example of the reference distribution, and extracts the probability density function P in the determined extraction section [xa, xb]. However, the present disclosure is not limited thereto. The extraction unit 53 may determine the extraction section [xa, xb] without using the reference distribution, and may extract the probability density function P in the determined extraction section [xa, xb].

In the gateway device 101 according to the embodiment of the present disclosure, the extraction unit 53 extracts a part of the probability density function P by using the predetermined values ya, yb determined in advance by using the frequency distribution D(UR0) of the reception intervals x under the situation where the utilization rate of the in-vehicle network 12 is 0%. However, the present disclosure is not limited thereto. The extraction unit 53 may extract a part of the probability density function P by using predetermined values determined in advance by using the frequency distribution D(UR10) of the reception intervals x under the situation where the utilization rate of the in-vehicle network 12 is 10%, for example.

Incidentally, a technology for more accurately detecting an unauthorized message in an in-vehicle network has been demanded.

For example, as an attack model by an unauthorized in-vehicle device, a so-called bus-occupied type attack model that suspends transmission of an authorized message from a normal in-vehicle device and transmits an unauthorized message in the same transmission cycle as the authorized message, is assumed. It is difficult for the technology described in PATENT LITERATURE 1 to detect the unauthorized message transmitted according to the bus-occupied type attack model.

Meanwhile, as a countermeasure against the bus-occupied type attack model, for example, a detection method of identifying whether or not a transmission source is an unauthorized in-vehicle device by using, as fingerprint information, a statistic regarding reception times of periodic messages such as a standard deviation of reception intervals of periodic messages, has been known.

However, transmission of an unauthorized message using so-called clock phishing is assumed. That is, regarding the bus-occupied type attack model, an unauthorized in-vehicle device mechanically learns transmission times of authorized messages from a normal in-vehicle device, and transmits unauthorized messages such that the standard deviation of the transmission intervals of the unauthorized messages becomes substantially equal to the standard deviation of the transmission intervals of the authorized messages. The conventional technology such as the technology described in PATENT LITERATURE 2 has a risk that the detection function is easily avoided by such clock phishing.

Specifically, according to verification performed by the inventors of the present application, if an unauthorized message that masquerades as an authorized message by spoofing a standard deviation of transmission intervals with an accuracy ranging from −30% to 30%, is transmitted, it is difficult to detect the unauthorized message by using fingerprint information.

Moreover, the present inventors, according to the following procedure, have evaluated the detection method in which a standard deviation of reception intervals of periodic messages is used as fingerprint information.

First, the present inventors generated a simulated in-vehicle network by connecting an in-vehicle device and a logger to a CAN bus. The in-vehicle device included an oscillator A having a clock frequency of 8 MHz and a frequency deviation of ±30 ppm.

Then, the present inventors set a cycle of periodic messages transmitted from the in-vehicle device to 100 milliseconds, and monitored the transmission intervals of the periodic messages in the in-vehicle device by using an oscilloscope. Moreover, the present inventors set the simulated in-vehicle network in the states where the utilization rate, i.e., traffic, of the network was 0%, 40%, and 80%, respectively, and monitored the reception intervals, in the logger, of the periodic messages from the in-vehicle device under the respective states.

Next, the present inventors mounted, instead of the oscillator A, an oscillator B having a clock frequency of 8 MHz and a frequency deviation of ±20 ppm to the in-vehicle device, and monitored the transmission intervals of the periodic messages in the in-vehicle device and the reception intervals in the logger under the respective states regarding the traffic in the same manner as described above.

Moreover, the present inventors mounted, instead of the oscillator A, an oscillator C having a clock frequency of 8 MHz and a frequency deviation of ±30 ppm to the in-vehicle device, and monitored the transmission intervals of the periodic messages in the in-vehicle device and the reception intervals in the logger under the respective states regarding the traffic in the same manner as described above.

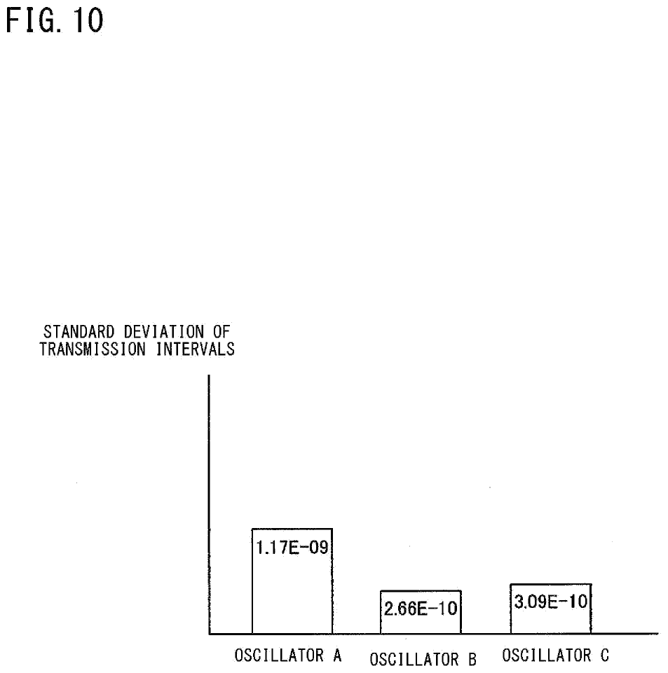

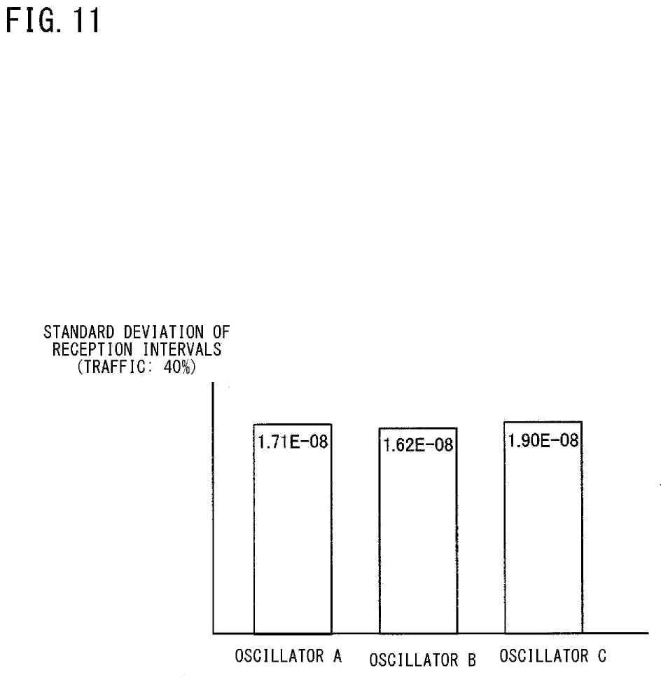

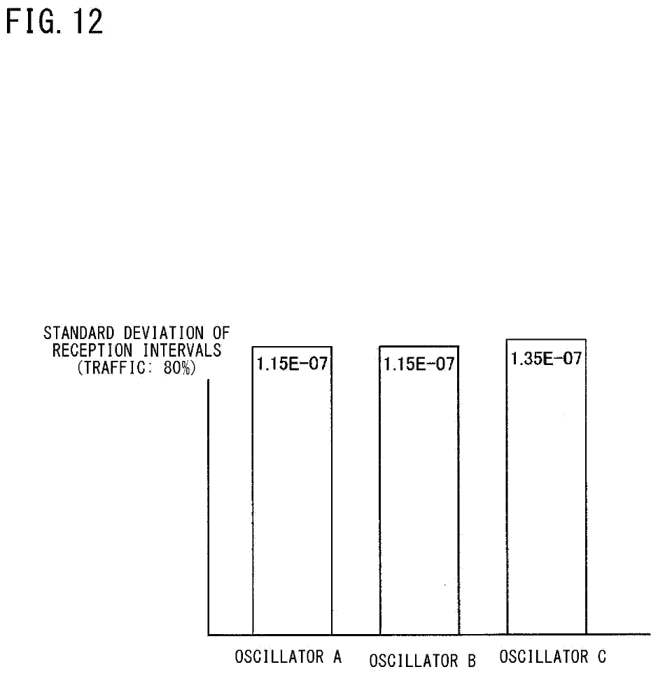

FIGS. 10 to 12 show results of the verification performed by the present inventors. FIG. 10 shows, for each oscillator mounted to the in-vehicle device, the standard deviation of the transmission intervals of the periodic messages in the in-vehicle device. FIG. 11 shows, for each oscillator mounted to the in-vehicle device, the standard deviation of the reception intervals of the periodic messages in the logger when the traffic is 40%. FIG. 12 shows, for each oscillator mounted to the in-vehicle device, the standard deviation of the reception intervals of the periodic messages in the logger when the traffic is 80%.

With reference to FIGS. 10 to 12, the standard deviation of the transmission intervals of the periodic messages in the in-vehicle device varies among the different oscillators mounted to the in-vehicle device, whereas there is no difference in standard deviation of the reception intervals of the periodic messages in the logger, from among when the traffic is 40% and from among when the traffic is 80%.

From the above, the present inventors have reached findings that it is difficult to distinguish between the oscillators, based on the standard deviation of the reception intervals of the periodic messages, and therefore, it is difficult to identify whether or not the transmission source is an unauthorized in-vehicle device, by using the detection method of the conventional art in which the standard deviation of the reception intervals of the periodic messages is used as fingerprint information.

Meanwhile, in the gateway device 101 according to the embodiment of the present disclosure, the acquisition unit 52 acquires a target distribution that is a distribution of reception intervals of periodic messages transmitted in the in-vehicle network 12. The extraction unit 53 extracts a part of the target distribution acquired by the acquisition unit 52, in accordance with a predetermined criterion. The detection unit 55 performs a detection process of detecting an unauthorized message, based on the part, of the target distribution, extracted by the extraction unit 53.

The detection method according to the embodiment of the present disclosure is a detection method of, by the gateway device 101, detecting an unauthorized message in the in-vehicle network 12. In this detection method, first, the gateway device 101 acquires a target distribution that is a distribution of reception intervals of periodic messages transmitted in the in-vehicle network 12. Next, the gateway device 101 extracts a part of the acquired target distribution, in accordance with a predetermined criterion. Next, the gateway device 101 performs a detection process of detecting an unauthorized message, based on the extracted part of the target distribution.

As described above, according to the configuration and method of extracting a part of a target distribution according to a predetermined criterion and detecting an unauthorized message, based on the extracted part of the target distribution, it is possible to extract, from the target distribution, a part in which characteristics, such as a clock frequency, of the transmission source in-vehicle device are reflected, and identify, based on the extracted part, whether or not the in-vehicle device as the transmission source is an unauthorized in-vehicle device.

Therefore, in the gateway device and the detection method according to the embodiment of the present disclosure, it is possible to more accurately detect an unauthorized message in the in-vehicle network.

The disclosed embodiment is merely illustrative in all aspects and should not be recognized as being restrictive. The scope of the present disclosure is defined by the scope of the claims rather than by the description above, and is intended to include meaning equivalent to the scope of the claims and all modifications within the scope.

The above description includes the features in the additional notes below.

[Additional Note 1]

A detection device configured to detect an unauthorized message in an in-vehicle network, including:

an acquisition unit configured to acquire a target distribution that is a distribution of reception intervals of periodic messages transmitted in the in-vehicle network;

an extraction unit configured to extract a part of the target distribution acquired by the acquisition unit, in accordance with a predetermined criterion; and

a detection unit configured to perform a detection process of detecting an unauthorized message, based on the part, of the target distribution, extracted by the extraction unit, wherein

the extraction unit generates a probability density function that approximates the target distribution, and a cumulative distribution function based on the probability density function, and

the extraction unit extracts, from the target distribution, a distribution within a range of values of reception intervals when values of probability in the generated cumulative distribution function are within a predetermined range.

[Additional Note 2]

A detection device, including a processor, configured to detect an unauthorized message in an in-vehicle network mounted in a vehicle,

the processor implementing:

an acquisition unit configured to acquire a target distribution that is a distribution of reception intervals of periodic messages transmitted in the in-vehicle network;

an extraction unit configured to extract a part of the target distribution acquired by the acquisition unit, in accordance with a predetermined criterion; and

a detection unit configured to perform a detection process of detecting an unauthorized message, based on the part, of the target distribution, extracted by the extraction unit.

### REFERENCE SIGNS LIST

1 vehicle
12 in-vehicle network
13 bus
14 bus
51 communication processing unit
52 acquisition unit
53 extraction unit
54 calculation unit
55 detection unit
56 storage unit
101 gateway device
111 in-vehicle communication device
111A TCU (in-vehicle communication device)
111B short-range wireless terminal device (in-vehicle communication device)
111C ITS wireless device (in-vehicle communication device)
112 port
121 bus connection device group
122, 122A, 122B, 122C control device
151 detection device
301 in-vehicle communication system

1. A detection device configured to detect an unauthorized message in an in-vehicle network, comprising:
an acquisition unit configured to acquire a target distribution that is a distribution of reception intervals of periodic messages transmitted in the in-vehicle network;
an extraction unit configured to extract a part of the target distribution acquired by the acquisition unit, in accordance with a predetermined criterion; and
a detection unit configured to perform a detection process of detecting an unauthorized message, based on the part, of the target distribution, extracted by the extraction unit.

2. The detection device according to claim 1, wherein the extraction unit extracts the part of the target distribution by using a reference distribution that is a distribution of the reception intervals of the periodic messages being transmitted under a situation where a predetermined condition is satisfied.

3. The detection device according to claim 2, wherein the extraction unit extracts a part of the target distribution by using a probability density function that approximates the target distribution, a cumulative distribution function based on the probability density function, and the reference distribution.

4. The detection device according to claim 2, wherein the predetermined condition is that a utilization rate of the in-vehicle network is lower than a utilization rate of the in-vehicle network when the target distribution is acquired.

5. The detection device according to claim 1, wherein the detection unit performs the detection process, based on a standard deviation of the reception intervals of the periodic messages in the part of the target distribution.

6. The detection device according to claim 1, wherein the detection unit performs the detection process, based on the number of peaks in the part of the target distribution.

7. The detection device according to claim 1, wherein the detection unit performs the detection process, based on a kurtosis of the part of the target distribution.

8. The detection device according to claim 1, further comprising a calculation unit configured to calculate a statistic of the reception intervals of the periodic messages, based on the target distribution acquired by the acquisition unit, wherein
the detection unit further performs a detection process of detecting an unauthorized message, based on a result of comparison of the statistic calculated by the calculation unit with a predetermined value.

9. A vehicle including the detection device according to claim 1.

10. A detection method performed by a detection device configured to detect an unauthorized message in an in-vehicle network, the method comprising:
acquiring a target distribution that is a distribution of reception intervals of periodic messages transmitted in the in-vehicle network;
extracting a part of the acquired target distribution in accordance with a predetermined criterion; and
performing a detection process of detecting an unauthorized message, based on the extracted part of the target distribution.

11. A non-transitory computer-readable storage medium having, stored therein, a detection program used in a detection device configured to detect an unauthorized message in an in-vehicle network,
the detection program causing a computer to function as:
an acquisition unit configured to acquire a target distribution that is a distribution of reception intervals of periodic messages transmitted in the in-vehicle network;
an extraction unit configured to extract a part of the target distribution acquired by the acquisition unit, in accordance with a predetermined criterion; and
a detection unit configured to perform a detection process of detecting an unauthorized message, based on the part, of the target distribution, extracted by the extraction unit.
